(19) United States
(12) Patent Application Publication
(10) Pub. No.: US 2019/0223404 A1
(43) Pub. Date: Jul. 25, 2019

(54) ANIMAL STRUCTURE

(71) Applicant: Innovation Pet, Inc., Huntington Beach, CA (US)

(72) Inventor: Timothy Taft, Huntington Beach, CA (US)

(21) Appl. No.: 16/253,676

(22) Filed: Jan. 22, 2019

Related U.S. Application Data
(60) Provisional application No. 62/620,122, filed on Jan. 22, 2018.

(51) Int. Cl. A01K 1/035; A01K 1/00; A01K 1/03

(52) U.S. Cl. CPC A01K 1/035; A01K 1/015; A01K 1/033; A01K 1/0035

(57) ABSTRACT

An animal structure fit for varying climates. The structure may have sub-assemblies that are assembled in a manufacturing facility, and then shipped as a group of sub-assemblies to an end customer. The animal structure may include a floor raised from the ground, insulation in walls, and insulated floor and top cover. A standard sized opening for animals to enter and exit may be placed in one of the walls. The top cover may be hinged for access to an interior of the animal structure, and the floor may be removable for ease of cleaning.

### CROSS-REFERENCE TO RELATED APPLICATIONS

This application claims the benefit of U.S. application Ser. No. 62/620,122, filed Jan. 22, 2018, the contents of which are expressly incorporated herein by reference.

### STATEMENT RE: FEDERALLY SPONSORED RESEARCH/DEVELOPMENT

Not Applicable

### BACKGROUND

Various types of housing for animals have been used ever since animals were domesticated. A variety of materials have been used for making the structural components of animal structures. In the past, wood was essentially the only choice, and remains popular today. More recently, plastics and metals have been used to create the structural components of animal structures.

The structures also have had various roof and siding configurations. Some have pitched roofs and straight sides. Others may have a flat panel roof with straight sides. Other structures use a dome configuration, creating an igloo shaped structure. Some of the structures are designed to sit on the ground, and may or may not include a floor.

Opening size and location have also varied on structures. Some structures have more than a single opening. However, most have a single opening through which animals can enter and leave. If the opening is centered on a side of the structure, wind may enter the animal structure, and the animal or animals can't escape the draft because there is not enough space to either side of the opening, an animal cannot fit without extending in to the opening. Offset openings on a side allow animals to more readily escape the wind by providing more solid wall to block the wind. Smaller openings also minimize wind penetration as well as reducing heat loss. However, larger animals may not be able to fit through the smaller opening.

In partial answer to the varying dog sizes, the pet industry has developed a few standard size doors for installation in walk through doors installed in walk through doors of human residential or commercial structures.

Rarely will any animal structure include a heater. Almost all animal structures are designed to be heated by the body heat of the animal or animals the structure is designed to house. Therefore, the animal structure must be designed and sized appropriately. Some of the most efficient designs are igloo shaped and cannot be easily packaged for shipping. Other shelters may be more easily shipped, but are not sufficiently weatherproof. Finally, depending on shape, the structure may be difficult to size properly for the animal or animals to both heat and move around in the structure.

Thus, here is a need for an animal structure which meets each of these competing requirements.

### BRIEF SUMMARY

Disclosed herein is an insulated animal structure. The insulation is enclosed in a plurality of side panels and a top cover. Optionally, a floor of the structure may also include insulation. The structure is partially pre-assembled in components designed in a modular fashion. These components may be shipped in much smaller container than would be required by a fully assembled structure and only require minimal assembly by an end user.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a perspective view of the animal structure with the top cover hinged open;

FIG. 2 shows a perspective vie of the animal structure of FIG. 1 with the top cover closed;

FIG. 3 shows a perspective view of the interior of the animal structure;

FIG. 4 shows a detail perspective view of the hinge attachment of the top cover to the side panels;

FIG. 5 shows a schematic cross section view of a side panel;

FIG. 6 shows a top cross sectional view of the animal structure which uses tongue and groove joints for the connection of the side panels to the posts;

FIG. 7 shows a top cross sectional view of the animal structure which uses both tongue and groove and butt joints for the connection of the side panels to the posts; shows a perspective view of adhesive applied to an inner layer panel;

FIG. 8 shows a perspective view of a side panel with the interior layer removed to expose the insulation layer; and

FIG. 9 shows a perspective view of a fully assembled side panel.

### DETAILED DESCRIPTION

Disclosed is an insulated animal structure. As further described below, the individual components may be assembled into component sub-assemblies. The individual components may include an insulated top cover and side panels. The component sub-assembles may be packaged for shipment in a smaller container than would be required by a fully assembled structure of similar size.

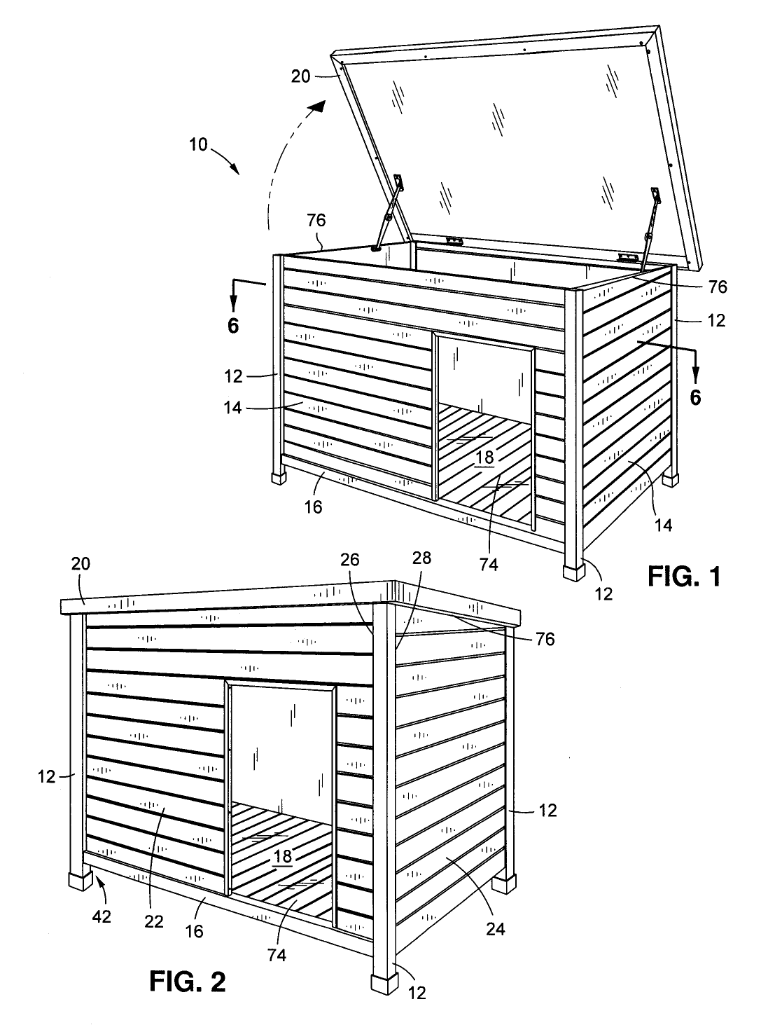

As shown in FIGS. 1-3, 6, and 7, the animal structure 10 may include posts 12, side panels 14, horizontal supports 16, a floor 18, and a top cover 20. The side panels 14 may attach to the posts 12. The horizontal supports 16 may attach to the side panels 14, or to two or more of the posts 12, or both. The horizontal supports 16 may support the floor 18. The top cover 20 may attach to one or more of the side panels 14. The top cover 20 may rest on top edges of the side panels 14 and on an end of the posts 12 when closed. The top cover 20 may hinge open around an axis defined by the top edge of one of the side panels 14.

The side panels 14 may be divided between front and rear side panels 22 and connecting side panels 24. One of the side panels may be located between two of the posts 12. Further, the same post 12 may be attached to more than one side panel 14. By way of example and not limitation, a post 12 may have a square transverse cross section. A first side 26 of the post 12 may be attached to a front and rear side panel 22. A second side 28 perpendicular to the first side 26 of the same post 12 may be attached to a connecting side panel 24. Each post 12 of the plurality of posts may be connected to each of the side panels 14 by a tongue and groove joint 30. The side panel 14 may have the tongue 32 and the post 12 may have the groove 34. Alternatively, the side panel 14 may have the groove 34 and the post 12 may have the tongue 32. The side panel 14 and post 12 may be secured in place by a mechanical fastener. A mechanical fastener, for example, a nail or a screw, may be driven in to the groove 34 and through the tongue 32, preventing the tongue 32 and groove 34 from moving relative to one another.

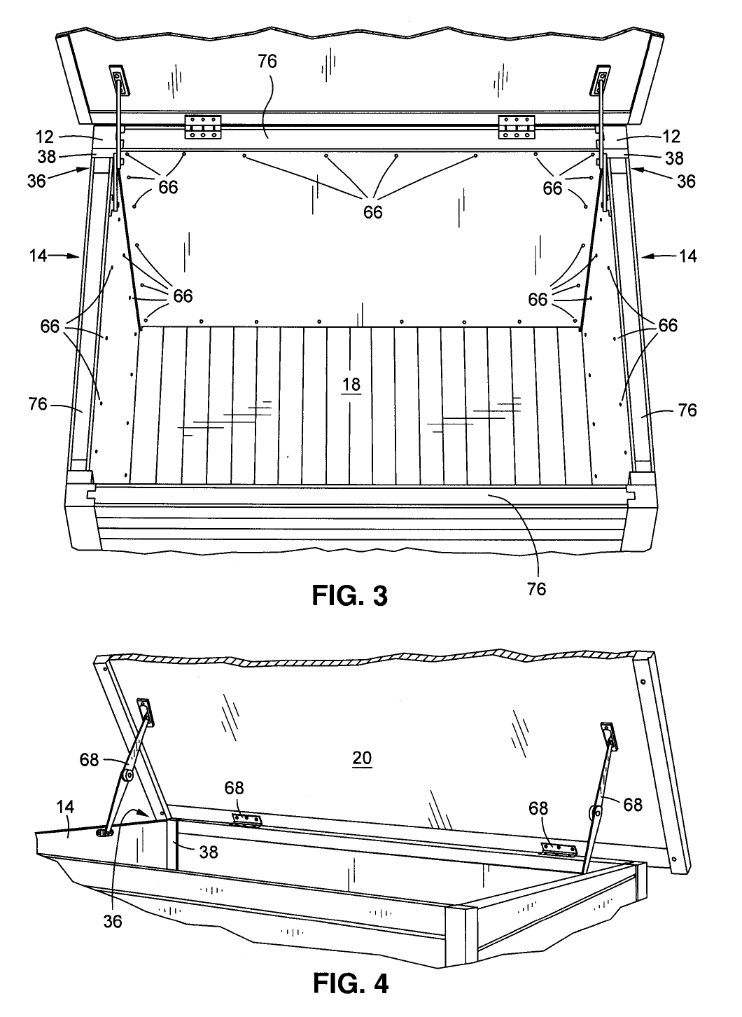

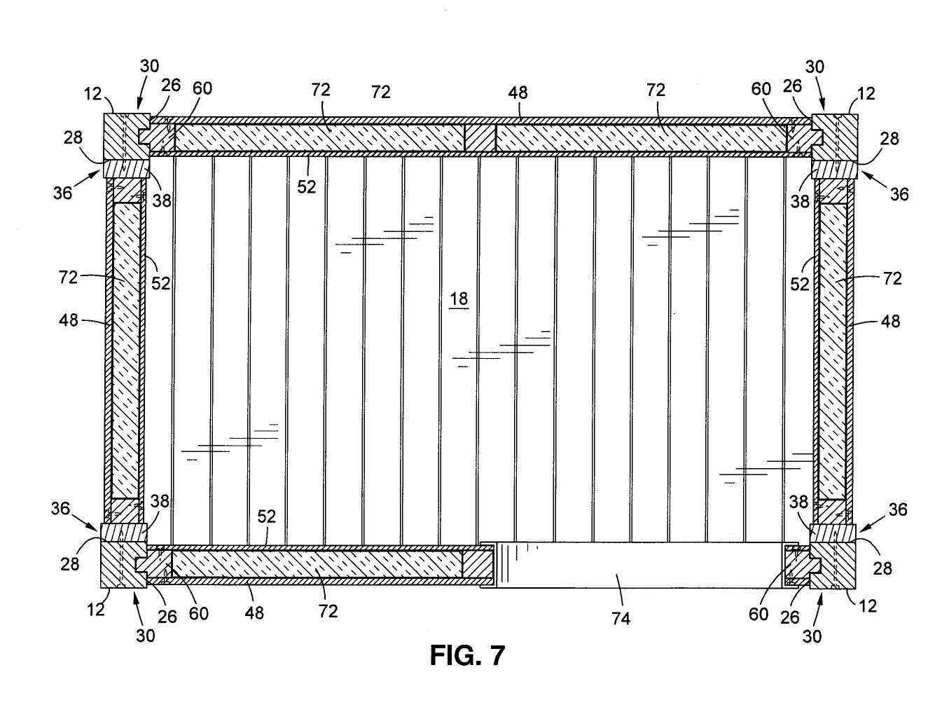

Alternatively, the side panels 14 may contact a post 12 using a butt joint 36. As shown in FIGS. 3 and 7, a connecting side panel 24 may have a cleat 38 which abuts the post 12 on the second side. A mechanical fastener, for example, a nail or a screw, may attach the cleat 38 to the post 12. The mechanical fastener may pass through the cleat 38 and in to the post 12. A structure 10 may use exclusively tongue joints 30. Alternatively, a structure 10 may use exclusively butt joints 36. Or, a structure 10 may use a combination of tongue joints 30 and butt joints 36. By way of example and not limitation, the front and rear side panels 22 may connect to the posts 12 by tongue and groove joints 30, and the connecting side panels 24 may connect to the posts 12 by butt joints 36. When butt joints 36 are used, any unsealed portions of the butt joint 36 may be sealed using standard construction caulking.

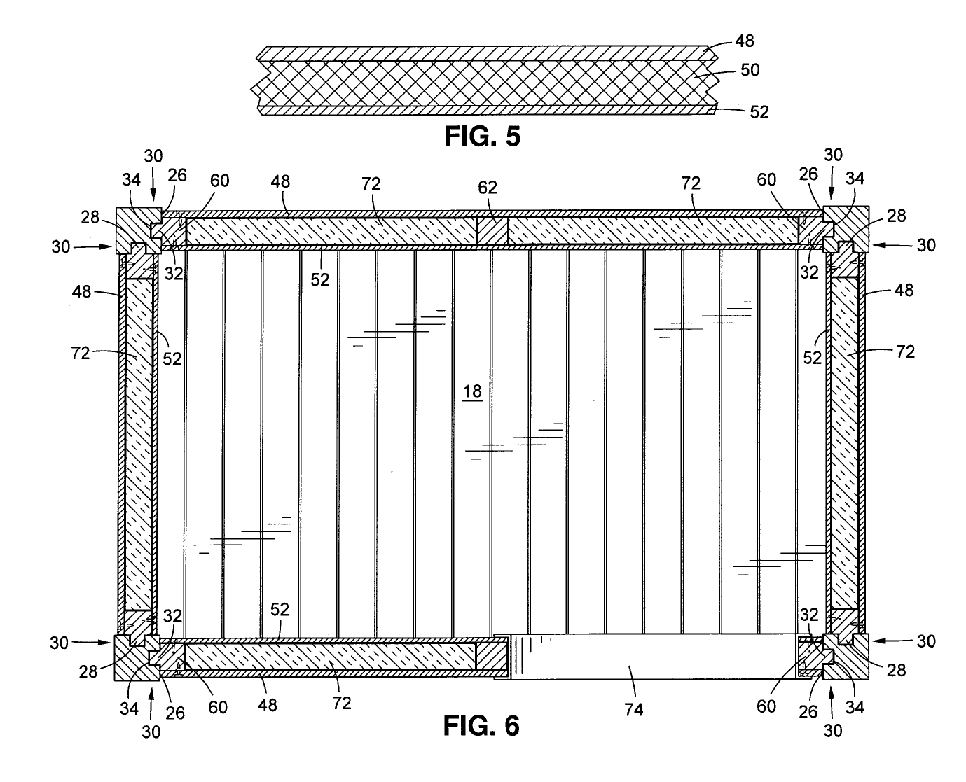

As shown in FIG. 5, the side panels 14 may have a plurality of layers. The side panel 14 may have an outer layer 48, an insulation layer 50, and an inner layer 52. The outer layer 48 may be made of a weatherproof material. By way of example and not limitation, the outer layer 48 may be made of a wooden siding, a composite siding, a vinyl siding, a plastic panel, or a plurality of smaller, overlapping panels. The outer layer 48 may be of any material which is weatherproof.

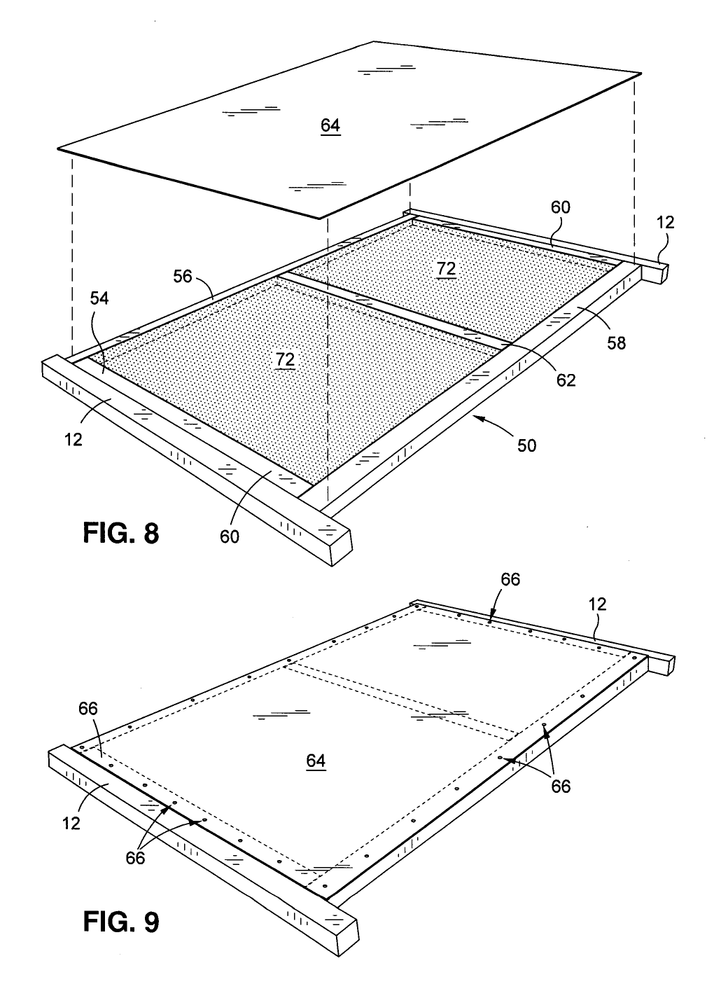

As shown in FIGS. 6-8, the insulation layer 50 may have two components. The first component of the insulation layer 50 may be a frame 54. The frame 54 may include a top rail 56, a bottom rail 58, outer vertical supports 60, and one or more inner vertical supports 62. The top rail 56, bottom rail 58, and vertical supports 60, 62 may form a grid pattern when assembled. Insulation 72 may be located in the space between the frame 54 elements 56, 58, 60, 62. By way of example and not limitation, Styrofoam insulation may be cut to size and placed in between the frame elements 56, 58, 60, 62. Alternatively, other forms of insulation 72 may be used. By way of example and not limitation, the insulation 72 may be formed from an expanding spray foam, cellulose, fiberglass, or mineral wool. The insulation 72 thickness may be sized up to a thickness of the frame elements 56, 58, 60, 62.

The side panels 14 may have an interior layer 52. As shown in FIGS. 6-9, the interior layer 52 may be a single panel 64. The single panel 64 may be wood. Alternatively, the panel may be, for example, a composite siding, a vinyl siding, a plastic panel, or a plurality of smaller, overlapping panels. An adhesive may be placed on a first surface of the interior layer 52. Alternatively, the interior layer 52 may be made from a plurality of pieces. The pieces may be of a similar size and shape. Alternatively, the pieces may be of a plurality of sizes or a plurality of shapes, or both.

When the interior layer 52 is a single panel 64, the single panel 64 may be sized to cover the frame 54 to an outer perimeter of the frame 54. As shown in FIG. 13, in addition to the adhesive, to fully secure the inner layer 52 single panel 64 to the frame 54 a plurality of mechanical fasteners 66 may be used. By way of example and not limitation, the mechanical fasteners may include nails, screws, or staples. The mechanical fasteners 66 may be placed at intervals near a perimeter of the single panel 64 so that the mechanical fasteners 66 pass through the single panel 64 and in to the frame 54. Alternatively, the adhesive alone or mechanical fasteners alone may be used to secure the single panel 64 to the side panel 14.

Referring again to FIGS. 1-3, opposing connecting side panels 24 of the animal structure may have a top edge 76 which slants from the front of the animal structure to the back. When the top cover 20 is closed, the top cover 20 may contact the top edges 76 of the side panels 14. In an alternative configuration, the top cover 20 may be pitched with a peak, so that it slants in more than one direction. By way of example and not limitation, the top cover 20 may have a peak in the center and slant downward from there toward the connecting side panels 24.

One or more of the side panels may have an opening 74. The opening 74 may be used by an animal to enter or exit the animal structure 10. The opening 74 may be sized to accommodate industry standard door sizes. By way of example and not limitation, the opening 74 may be sized for dog doors typically made to be placed in a cut out of a human-sized exterior door in a structure designed for human use. Other closures for the opening 74 may be used. For example, a vinyl sheet with longitudinal cuts, such as used on various types of walk-in refrigeration units may be used.

A horizontal support 16 may be attached to the first side 26 of the post 12 on the underside of the front and rear side panel 22. The horizontal support 16 may have a first end 40 and a second end 42. Similar to the side panels, a tongue and groove joint 30 may be used to connect the horizontal support 16 to a post 12. By way of example and not limitation, the first end 40 may have a tongue 32 and the corresponding post 12, a groove 34. The second end may also have a tongue 32 and the corresponding post 12 a groove. Alternatively, the post 12 may have the tongue 32 and the first and second ends 40, 42 of the horizontal support 16 the groove 34. The tongue 32 and groove 34 configuration may correspond to that of the side panels 14 and posts 12. That is, if the side panels 14 have tongues 32, then the horizontal supports 16 may also have tongues 32. If the side panels 14 have grooves 34, then the horizontal supports 16 may also have grooves 34. A mechanical fastener, for example, a nail or a screw, may be driven in to the groove 34 and through the tongue 32, preventing the tongue 32 and drove 34 from moving relative to one another.

Alternatively, the horizontal support 16 may connect with a butt joint 36. The horizontal support 16 may have a cleat 38. When the horizontal support 16 has a cleat 38, the horizontal support 16 may be attached to the post 12 using a mechanical fastener. The mechanical fastener may be, for example, a nail or a screw. Alternatively, the cleat 38 may be attached to the post 12 using an adhesive.

The floor 18 may rest on the horizontal supports 16. Because the horizontal support 16 is spaced from a lower end 44, the horizontal support 16 is raised off the ground. By way of example and not limitation, there may be one horizontal support 16 adjacent to a lower edge 46 of a first of the front and rear side panels 22 and there may be a second horizontal support 16 adjacent to a lower edge 46 of a second of the front and rear side panels 22. The floor 18 may be a simple single panel. Alternatively, the floor 18 may be a panel with a frame on an undersurface of the panel. The floor 18 may incorporate insulation in a manner similar to the side panels 14, as was described in detail above. As another alternative, all of the side panels 14 may have a horizontal support 16, and the floor 18 may rest on all of the horizontal supports 16.

To assemble the animal structure 10, the posts 12 may be connected to side panels 14 in the manner described above. By way of example and not limitation, when posts 12 with a square transverse cross section are used, an assembled animal structure 12 may have four posts 12 and four side panels 14. At least two of the side panels 14 may have a horizontal support 16 attached along a bottom edge as described above. The floor 18 may rest on these horizontal supports 18.

Once the side panels 14 and posts 12 are assembled, the top cover 20 may be added. Referring to FIGS. 1 and 3, the top cover 20 may be a single flat panel. The top cover 20 may include weather proofing material on the outer surface. By way of example and not limitation, the weather proofing material may be roofing shingles. The top cover 20 may be attached to the side panels 14 by hinges 68. The hinges 68 may be attached to more than one side panel 14. More than one type of hinge 68 may be used. By way of example and not limitation, butt hinges, knife hinges, or piano hinges may be used. As shown in FIG. 3, two butt hinges may be used to connect the top cover 20 to a front and rear side panel 22 and one knife hinge may connect the top cover 20 to a connecting side panel 24 on opposite sides of the structure.

As shown in FIG. 4, because the top cover 20 may hinge open, an interior 70 of the animal structure 20 may be accessed. The interior 70 is defined by the combination of the posts 12, side panels 14 and the floor 18. The floor 18 may be installed by resting the floor 18 on top of two or more of the horizontal supports 16. When a user may access the interior 70, the user may be able to remove the floor 18 by lifting the floor 18 through the opening created by the hinged top cover 20. Alternatively, the floor 18 may be attached to the horizontal supports 16 by, for example, mechanical fasteners or adhesives.

Alternatively, the top cover 20 may be placed on top of the side panels 14. When the top cover 20 is placed on top of the side panels 14, it may be held in place by blocking elements on the underside of the top cover 20. The blocking elements contact the side panels 14 and prevent the top cover 20 from moving laterally with respect to the side panels 14.

The top cover 20 may have a composition similar to the side panels 14. The top cover 20 may also have a plurality of layers, including an outer layer 48, an insulation layer 50, and an inner layer 52. The layers may be assembled in the same manner as the side panels 14, which is described in detail above.

The entire exterior of the animal structure 10 may be covered with a weather proofing finish. The weather proofing finish may be, for example, polyurethane.

The above description is given by way of example, and not limitation. Given the above disclosure, one skilled in the art could devise variations that are within the scope and spirit of the invention disclosed herein, including various ways of arranging the posts and side panels. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A system of components for assembly in to an animal structure, the system comprising:
a plurality of posts;
a plurality of side panels having a first edge and a second edge, a siding layer, an insulation layer, and an interior layer, each of the plurality of side panels configured to attach to one of the plurality of posts on the first edge, and configured to attach another of the plurality of posts on the second edge;
at least two horizontal supports including a first end and a second end, each of the at least two horizontal supports configured to connect to one of the plurality of posts on the first end, and to attach another of the plurality of posts on the second end;
a floor configured to abut the horizontal supports; and
a top cover configured to be attached to at least one of the plurality of side panels by at least one hinge.

2. The system of claim 1, wherein the floor includes a floor insulation layer.

3. The system of claim 1, wherein the roof includes a roof insulation layer.

4. The structure of claim 1, wherein the floor is configured to rest on top of the horizontal supports and is removable from an assembled animal structure for cleaning.

5. The structure of claim 1, wherein, when assembled, the top cover slants downward from a top edge of one side panel down to a top edge of an opposite side panel.

6. The structure of claim 1, wherein the top cover includes a weatherproofing finish.

7. The structure of claim 1, wherein at least two of the plurality of side panels connect to the respective posts via a tongue and groove joint.

8. The structure of claim 1, wherein the top cover has a flat top.

9. An animal structure suitable for a variety of climatic conditions, the structure comprising:
a plurality of posts;
a plurality of side panels, each of the plurality of side panels located between two of plurality of posts, and including a siding layer and an insulation layer;
at least two horizontal supports including a first end and a second end, the first end being connected to one of the plurality of posts, and the second end being connected to another of the plurality of posts;
a floor adjacent the two horizontal supports, the floor, the plurality of posts, and the plurality of the side panels defining an interior; and
a top cover covering the interior, and connected to the interior by hinges which allow access the top cover to hinge open.

10. The animal structure of claim 9, wherein the floor is spaced apart from an end of each of the plurality posts, lifting the floor from the ground when the structure is assembled.

11. The animal structure of claim 9, further comprising an opening in one of the plurality of side panels.

12. The structure of claim 11, wherein the opening in one of the plurality of side panels is sized to accept standardized dog doors.

13. The animal structure of claim 9, wherein the floor includes a floor insulation layer.

14. The animal structure of claim 9, wherein the insulation layer is composed of Styrofoam.

15. The animal structure of claim 9, wherein the insulation layer includes a frame surrounding the insulation.

16. The animal structure of claim 9, wherein the plurality of side panels includes an interior layer.

17. The animal structure of claim 16, wherein the interior layer is a single panel.

18. The animal structure of claim 17, wherein the single panel is attached to each of the plurality of side panels by an adhesive.

19. The animal structure of claim 17, wherein the panel is attached to each of the plurality of side panels by a plurality of mechanical fasteners.

20. The animal structure of claim 17, wherein the panel is attached to each of the plurality of side panels by both an adhesive and a plurality of mechanical fasteners.
